(19) United States
(12) Patent Application Publication
(10) Pub. No.: US 2025/0347821 A1
(43) Pub. Date: Nov. 13, 2025

(54) AEROELECTROMAGNETIC DATA INVERSION METHOD AND SYSTEM BASED ON APPROXIMATE JACOBIAN MATRIX

(71) Applicant: Institute of Geology and Geophysics, Chinese Academy of Sciences, Beijing (CN)

(72) Inventors: Da LEI, Beijing (CN); Qingyun DI, Beijing (CN); Hao REN, Beijing (CN); Zhongxing WANG, Beijing (CN); Ruo WANG, Beijing (CN); Qihui ZHEN, Beijing (CN); Changmin FU, Beijing (CN); Zhiguo AN, Beijing (CN)

(21) Appl. No.: 19/046,863

(22) Filed: Feb. 6, 2025

(30) Foreign Application Priority Data
May 10, 2024 (CN) 202410576270.0

(51) Int. Cl. G01V 3/38; G06F 17/16

(52) U.S. Cl. CPC G01V 3/38; G06F 17/16

(57) ABSTRACT

An aeroelectromagnetic data inversion method and a system based on an approximate Jacobian matrix are provided. The method includes following steps: dividing an inversion target area into grids, and setting an initial underground space model based on divided grids; constructing an aerial transient electromagnetic three-dimensional inversion target function based on the initial underground space model, and calculating a weighting term of the model based on observation data and the inversion target function; constructing the approximate Jacobian matrix, calculating an iterative equation set based on the approximate Jacobian matrix, and updating the inversion target function based on the iterative equation set to obtain an inversion model; and inputting aerial transient electromagnetic observation data into the inversion model for inversion to obtain inversion results of each induced polarization parameter.

### CROSS-REFERENCE TO RELATED APPLICATIONS

This application claims priority to Chinese Patent Application No. 202410576270.0, filed on May 10, 2024, the contents of which are hereby incorporated by reference.

### TECHNICAL FIELD

The disclosure belongs to the technical field of geophysical exploration inversion, and particularly relates to an aeroelectromagnetic data inversion method and a system based on an approximate Jacobian matrix.

### BACKGROUND

In geophysical inversion, the calculation of a Jacobian matrix is the most time-consuming, which is the biggest factor restricting the speed of inversion calculation. However, the aeroelectromagnetic method has a large amount of data, and the inversion speed is an important factor restricting the practicability of the algorithm. In order to speed up the inversion, it is necessary to improve the inversion process and reduce the amount of calculation required in the inversion process as much as possible. At present, there is a lack of an effective acceleration method to solve the problem of slow inversion speed of the aeroelectromagnetic method in the time domain.

### SUMMARY

The disclosure aims at solving shortcomings of the prior art, and provides an aeroelectromagnetic data inversion method and a system based on an approximate Jacobian matrix, which may quickly solve an inverse problem by approximating gradient information.

In order to achieve the above purposes, the present disclosure provides following schemes.

An aeroelectromagnetic data inversion method based on an approximate Jacobian matrix, including following steps:
dividing an inversion target area into grids, and setting an initial underground space model based on the divided grids;
constructing an aerial transient electromagnetic three-dimensional inversion target function based on the initial underground space model, and calculating a weighting term of the model based on observation data and the inversion target function;
constructing the approximate Jacobian matrix, calculating an iterative equation set based on the approximate Jacobian matrix, and updating the inversion target function based on the iterative equation set to obtain an inversion model;
inputting aerial transient electromagnetic observation data into the inversion model for inversion to obtain inversion results of each induced polarization parameter.

Optionally, the inversion target function includes:

$$φ ( m ) = {φ}_{d} + {λ}_{1} {φ}_{m 1} + {λ}_{1} {φ}_{m 2} \\ {φ}_{d} = {[ {d}_{obs} - F ( m ) ]}^{T} {W}_{d}^{T} {W}_{d} [ {d}_{obs} - F ( m ) ] \\ {φ}_{m 1} = {( m - {m}_{0} )}^{T} {W}_{m}^{T} {W}_{m} ( m - {m}_{0} ) \\ {φ}_{m 2} = {s}^{τ} s ,$$

where λ₁ and λ₂ are regularization factors, W_{d} is a data weighting matrix, Wₘ is an improved model weighting matrix, s is a data difference matrix, d_{obs} is observation data, F(m) is the transient electromagnetic response of the underground space model, m is a parameter vector of the underground space model, m₀ is a reference model vector of the underground space, and T is a matrix transposition.

Optionally, a calculation method of the weighting term includes: using an improved Laplace operator to calculate the weighting term;
where diagonal elements of the improved Laplace operator are:

$$c = \frac{1}{\sqrt{{m ( i , j , k )}^{2} + α}} ,$$

where m(i,j,k) is an electromagnetic parameter value in the (i,j,k)-th model grid, i is a grid number in x direction, j is a grid number in y direction, k is a grid number in z direction, and a is a constant; and
off-diagonal elements are arranged in a form of central difference, and difference coefficients in three directions are cₓ, c_{y}, and c_{z}, respectively:

$${c}_{x} = - w * \frac{Δ x ( i )}{Δ x ( i ) + Δ x ( i \pm 1 )} * \frac{1}{\sqrt{{m ( i , j , k )}^{2} + α}} \\ {c}_{y} = - w * \frac{Δ y ( j )}{Δ y ( j ) + Δ y ( j \pm 1 )} * \frac{1}{\sqrt{{m ( i , j , k )}^{2} + α}} \\ {c}_{z} = - w * \frac{Δ z ( k )}{Δ z ( k ) + Δ z ( k \pm 1 )} * \frac{1}{\sqrt{{m ( i , j , k )}^{2} + α}}$$

where w is a weighting coefficient, Δx is a grid size of the initial underground space model in the x direction, Δy is a grid size of the initial underground space model in the y direction, and Δz is a grid size of the initial underground space model in the z direction.

Optionally, the construction method of the approximate Jacobian matrix includes the following steps:
deriving the parameter vector of the underground space model by adjoint forward to obtain the Jacobian matrix:

$$J = {L}^{T} {K}^{- 1} ( \frac{\partial P}{\partial m} - \frac{\partial K}{\partial m} {E}_{s} ) ,$$

where J is the Jacobian matrix of the forward operator, L is the interpolation operator for converting the electric field component into the magnetic field component, P is the electric field value of the background field, K is the forward operator, and Eₛ is the electric field value of the scattering field;
solving the transposed matrix of the Jacobian matrix:

$${J}^{T} = ( \frac{\partial P}{\partial m} - \frac{\partial K}{\partial m} {E}_{s} ) {K}^{- 1} L ;$$

optimizing the interpolation operator, and selecting the four field value calculation points in the neighborhood of the measuring point in the divided grids to obtain the approximate interpolation operator L′; and
replacing the interpolation operator in the transposed matrix of the Jacobian matrix with the approximate interpolation operator to obtain the approximate Jacobian matrix.

Optionally, a method for obtaining the iterative equation set includes the following steps:
calculating the first partial derivative matrix of the observation data with respect to the model variables and the second partial derivative matrix of the data difference with respect to the model variables;
constructing the updated variables of the model variables based on the inversion target function and the second partial derivative matrix:

$$Δ m = {( {J}^{T} {W}_{d}^{T} {W}_{d} J + {λ}_{1} {W}_{m}^{T} {W}_{m} + {λ}_{2} {B}_{s}^{T} {B}_{S} )}^{- 1} ( {J}^{T} {W}_{m}^{T} {W}_{m} ( F ( {m}_{0} ) - {d}_{obs} ) - {λ}_{2} {B}_{s}^{T} s ) \\ {λ}_{1} = \frac{{b}_{1}}{{n}_{iter}^{{c}_{1}}} \frac{{‖ {J}^{T} {W}_{d}^{T} {W}_{d} Jx ‖}_{2}}{{‖ {W}_{m}^{T} {W}_{m} x ‖}_{2}} \\ {λ}_{2} = \frac{{b}_{2}}{{n}_{iter}^{{c}_{2}}} \frac{{‖ {J}^{T} {W}_{d}^{T} {W}_{d} Jx ‖}_{2}}{{‖ {B}_{s}^{T} {B}_{s} x ‖}_{2}} ,$$

where J is the Jacobian matrix of the forward operator, s is the data difference matrix, F(m₀) is the forward numerical simulation value of the reference model vector, Bₛ is the second partial derivative matrix of s about the model variables, niter is the number of iterations, and b₁, b₂, c₁ and c₂ are the constants;
obtaining the iterative equation set based on the updated variables:

$${m}_{k + 1} = {m}_{k} + Δ m , \\ {m}_{k + 1} = {m}_{k} + {( {J}_{k}^{T} {W}_{d}^{T} {W}_{d} {J}_{k} + {λ}_{1} {W}_{m}^{T} {W}_{m} + {λ}_{2} {B}_{sk}^{T} {B}_{sk} )}^{- 1} ( {J}_{k}^{T} {W}_{m}^{T} {W}_{m} ( F ( {m}_{k} ) - {d}_{obs} ) - {λ}_{2} {B}_{sk}^{T} {s}_{k} ) ,$$

where mₖ is the model variable after the k-th iteration, Jₖ is the Jacobian matrix of the forward operator after the k-th iteration, sₖ is the data difference matrix after the k-th iteration, and Bₛₖ is the second partial derivative matrix of sₖ about the model variables.

The disclosure also provides an aeroelectromagnetic data inversion system based on the approximate Jacobian matrix, where the inversion system uses the inversion method described in any one of the above, including a grid division module, a target function construction module, an inversion model construction module, and an inversion module;
the grid division module is used for grid division of the inversion target area, and setting the initial underground space model based on the divided grids;
the target function construction module constructs the aerial transient electromagnetic three-dimensional inversion target function based on the initial underground space model, and calculates the weighting term of the model based on the observation data and the inversion target function;
the inversion model construction module is used for constructing the approximate Jacobian matrix, calculating the iterative equation set based on the approximate Jacobian matrix, and updating the inversion target function based on the iterative equation set to obtain the inversion model;
the inversion module inputs the aerial transient electromagnetic observation data into the inversion model for inversion to obtain the inversion results of each induced polarization parameter.

Optionally, the inversion target function includes:

$$φ ( m ) = {φ}_{d} + {λ}_{1} {φ}_{m 1} + {λ}_{1} {φ}_{m 2} \\ {φ}_{d} = {[ {d}_{obs} - F ( m ) ]}^{T} {W}_{d}^{T} {W}_{d} [ {d}_{obs} - F ( m ) ] \\ {φ}_{m 1} = {( m - {m}_{0} )}^{T} {W}_{m}^{T} {W}_{m} ( m - {m}_{0} ) \\ {φ}_{m 2} = {s}^{T} s ,$$

where λ₁ and λ₂ are the regularization factors, W_{d} is the data weighting matrix, Wₘ is the improved model weighting matrix, s is the data difference matrix, d_{obs} is the observation data, F(m) is the transient electromagnetic response of the underground space model, m is the parameter vector of the underground space model, m₀ is the reference model vector of the underground space, and T is the matrix transposition.

Optionally, the calculation method of the weighting term includes: using the improved Laplace operator to calculate the weighting term;

where the diagonal elements of the improved Laplace operator are:

$$c = \frac{1}{\sqrt{{m ( i , j , k )}^{2} + α}} ,$$

where m(i,j,k) is the electromagnetic parameter value in the (i,j,k)-th model grid, i is the grid number in the x direction, j is the grid number in the y direction, k is the grid number in the z direction, and α is the constant; and
the off-diagonal elements are arranged in the form of the central difference, and the difference coefficients in the three directions are cₓ, c_{y}, and c_{z}, respectively:

$${c}_{x} = - w * \frac{Δ x ( i )}{Δ x ( i ) + Δ x ( i \pm 1 )} * \frac{1}{\sqrt{{m ( i , j , k )}^{2} + α}}$$

$${c}_{y} = - w * \frac{Δ y ( j )}{Δ y ( j ) + Δ y ( j \pm 1 )} * \frac{1}{\sqrt{{m ( i , j , k )}^{2} + α}}$$

$${c}_{z} = - w * \frac{Δ z ( k )}{Δ z ( k ) + Δ z ( k \pm 1 )} * \frac{1}{\sqrt{{m ( i , j , k )}^{2} + α}} ,$$

where w is the weighting coefficient, Δx is the grid size of the initial underground space model in the x direction, Δy is the grid size of the initial underground space model in the y direction, and Δz is the grid size of the initial underground space model in the z direction.

Optionally, the construction method of the approximate Jacobian matrix includes the following steps:
deriving the parameter vector of the underground space model by adjoint forward to obtain the Jacobian matrix:

$$J = {L}^{T} {K}^{- 1} ( \frac{\partial P}{\partial m} - \frac{\partial K}{\partial m} {E}_{s} ) ,$$

where J is the Jacobian matrix of the forward operator, L is the interpolation operator for converting the electric field component into the magnetic field component, P is the electric field value of the background field, K is the forward operator, and Eₛ is the electric field value of the scattering field;
solving the transposed matrix of the Jacobian matrix:

$${J}^{T} = ( \frac{\partial P}{\partial m} - \frac{\partial K}{\partial m} {E}_{s} ) {K}^{- 1} L ;$$

optimizing the interpolation operator, and selecting the four field value calculation points in the neighborhood of the measuring point in the divided grids to obtain the approximate interpolation operator L′; and
replacing an interpolation operator in the transposed matrix of the Jacobian matrix with the approximate interpolation operator to obtain the approximate Jacobian matrix.

Optionally, a method for obtaining the iterative equation set includes the following steps:
calculating the first partial derivative matrix of the observation data with respect to the model variables and the second partial derivative matrix of the data difference with respect to the model variables;
constructing the updated variables of the model variables based on the inversion target function and the second partial derivative matrix:

$$Δ m = {( {J}^{T} {W}_{d}^{T} {W}_{d} J + {λ}_{1} {W}_{m}^{T} {W}_{m} + {λ}_{2} {B}_{s}^{T} {B}_{s} )}^{- 1} ( {J}^{T} {W}_{m}^{T} {W}_{m} ( F ( {m}_{0} ) - {d}_{obs} ) - {λ}_{2} {B}_{s}^{T} s )$$

$${λ}_{1} = \frac{{b}_{1}}{{n}_{iter}^{{c}_{1}}} \frac{{‖ {J}^{T} {W}_{d}^{T} {W}_{d} Jx ‖}_{2}}{{‖ {W}_{m}^{T} {W}_{m} x ‖}_{2}}$$

$${λ}_{2} = \frac{{b}_{2}}{{n}_{iter}^{{c}_{2}}} \frac{{‖ {J}^{T} {W}_{d}^{T} {W}_{d} Jx ‖}_{2}}{{‖ {B}_{s}^{T} {B}_{s} x ‖}_{2}} ,$$

where J is the Jacobian matrix of the forward operator, s is the data difference matrix, F(m₀) is the forward numerical simulation value of the reference model vector, Bₛ is the second partial derivative matrix of s about the model variables, nᵢₜₑᵣ is the number of iterations, and b₁, b₂, c₁, and c₂ are the constants;
obtaining the iterative equation set based on the updated variables:

$${m}_{k + 1} = {m}_{k} + Δ m ,$$

$${m}_{k + 1} = {m}_{k} + {( {{J}_{k}}^{T} {W}_{d}^{T} {W}_{d} {J}_{k} + {λ}_{1} {W}_{m}^{T} {W}_{m} + {λ}_{2} {B}_{sk}^{T} {B}_{sk} )}^{- 1} ( {{J}_{k}}^{T} {W}_{m}^{T} {W}_{m} ( F ( {m}_{k} ) - {d}_{obs} ) - {λ}_{2} {B}_{sk}^{T} {s}_{k} ) ,$$

where mₖ is the model variable after the k-th iteration, Jₖ is the Jacobian matrix of the forward operator after the k-th iteration, sₖ is the data difference matrix after the k-th iteration, and Bₛₖ is the second partial derivative matrix of sₖ about the model variables.

Compared with the prior art, the disclosure has beneficial effects that: according to the disclosure, the inverse problem is quickly solved by approximating gradient information, and the approximate calculation method reduces the number of required calculation equation sets and significantly shortens the time required for inversion without affecting the inversion accuracy.

### BRIEF DESCRIPTION OF THE DRAWINGS

In order to explain the embodiments of the present disclosure or the technical schemes in the prior art more clearly, the drawings needed in the embodiments will be briefly introduced below. Apparently, the drawings in the following description are only some embodiments of the present disclosure. For one of ordinary skill in the art, other drawings may be obtained according to these drawings without paying creative labor.

FIG. 1 is a schematic flow diagram of a method according to embodiments of the present disclosure.

FIG. 2 is a schematic diagram of the XOY plane for approximately calculating a Jacobian matrix of multiple measuring points according to the embodiments of the present disclosure.

FIG. 3 is a schematic diagram of a system structure of the embodiments of the present disclosure.

FIG. 4 is a schematic diagram of a spatial initial model according to the embodiments the present disclosure.

FIG. 5A is a schematic diagram for comparing inversion results of four induced polarization parameters according to the embodiments of the present disclosure.

FIG. 5B is a schematic diagram for comparing the inversion results of the four induced polarization parameters according to the embodiments of the present disclosure.

FIG. 5C is a schematic diagram for comparing the inversion results of the four induced polarization parameters according to the embodiments of the present disclosure.

FIG. 5D is a schematic diagram for comparing the inversion results of the four induced polarization parameters according to the embodiments of the present disclosure.

FIG. 5E is a schematic diagram for comparing the inversion results of the four induced polarization parameters according to the embodiments of the present disclosure.

FIG. 5F is a schematic diagram for comparing the inversion results of the four induced polarization parameters according to the embodiments of the present disclosure.

FIG. 5G is a schematic diagram for comparing the inversion results of the four induced polarization parameters according to the embodiments of the present disclosure.

FIG. 5H is a schematic diagram for comparing the inversion results of the four induced polarization parameters according to the embodiments of the present disclosure.

FIG. 6 is a schematic diagram showing the influence of the Jacobian matrix calculation method with the same approximation degree on the calculation speed according to the embodiments of the present disclosure.

### DETAILED DESCRIPTION OF THE EMBODIMENTS

In the following, the technical schemes in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features, and advantages of the present disclosure more obvious and easier to understand, the present disclosure will be further described in detail with the attached drawings and specific embodiments.

### Embodiment 1

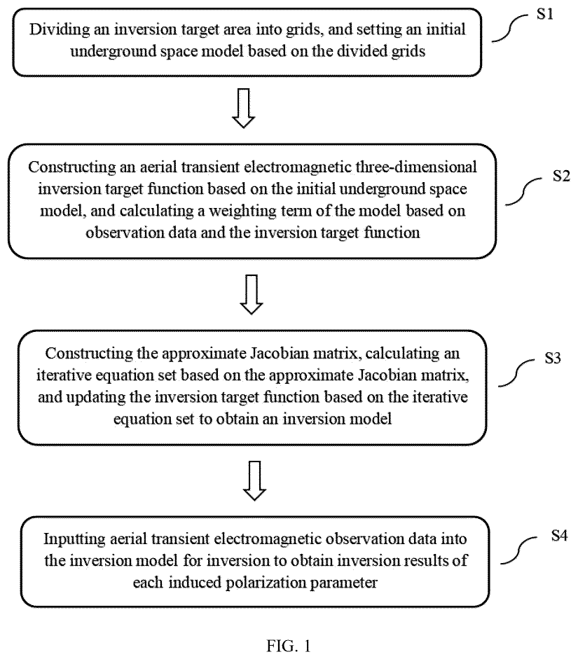

In this embodiment, as shown in FIG. 1, an aeroelectromagnetic data inversion method based on an approximate Jacobian matrix includes the following steps:
S1, dividing an inversion target area into grids, and setting an initial underground space model based on the divided grids.

In this embodiment, the inversion target area is divided into hexahedral grids, and the initial underground space model is set. If there is a prior model, it may be set as the prior model, and if there is no prior model, it may be set as a uniform half-space model. The transient electromagnetic response of the initial underground space model is obtained by forward calculation of the initial model.
S2, constructing an aerial transient electromagnetic three-dimensional inversion target function based on the initial underground space model, and calculating a weighting term of the model based on observation data and the inversion target function. The inversion target function includes:

$$φ ( m ) = {φ}_{d} + {λ}_{1} {φ}_{m 1} + {λ}_{1} {φ}_{m 2}$$

$${φ}_{d} = {[ {d}_{obs} - F ( m ) ]}^{T} {W}_{d}^{T} {W}_{d} [ {d}_{obs} - F ( m ) ]$$

$${φ}_{m 1} = {( m - {m}_{0} )}^{T} {W}_{m}^{T} {W}_{m} ( m - {m}_{0} )$$

$${φ}_{m 2} = {s}^{T} s ,$$

where λ₁ and λ₂ are regularization factors, W_{d} is a data weighting matrix, Wₘ is an improved model weighting matrix, s is a data difference matrix, d_{obs} is observation data, F(m) is transient electromagnetic response of the underground space model, m is a parameter vector of the underground space model, m₀ is a reference model vector of the underground space, and T is a matrix transposition.

It should be noted that m here is a model parameter vector of a current iteration; if no prior model is used, m₀ is the reference model vector of the last iteration in underground space; and if the prior model is used, m₀ is the reference model vector of the prior model in each iteration.

Inputting the observation data (induced electromotive force attenuation curve) and the position of the measuring point into an inversion program, determining the data weighting term according to the data, and the expression of a diagonal matrix of the data weighting term is:

$${W}_{d} = diag ( \frac{1}{\sqrt{{d}_{obs}^{2}}} ) .$$

A calculation method of the weighting term includes: using an improved Laplace operator to calculate the weighting term;
where diagonal elements of the improved Laplace operator are:

$$c = \frac{1}{\sqrt{{m ( i , j , k )}^{2} + α}} ,$$

where m(i,j,k) is an electromagnetic parameter value in the (i,j,k)-th model grid, i is a grid number in x direction, j is a grid number in y direction, k is a grid number in z direction, and α is a constant; and
off-diagonal elements are arranged in a form of central difference, and difference coefficients in three directions are cₓ, c_{y}, and c_{z} respectively:

$${c}_{x} = - w * \frac{Δ x ( i )}{Δ x ( i ) + Δ x ( i \pm 1 )} * \frac{1}{\sqrt{{m ( i , j , k )}^{2} + α}}$$

$${c}_{y} = - w * \frac{Δ y ( j )}{Δ y ( j ) + Δ y ( j \pm 1 )} * \frac{1}{\sqrt{{m ( i , j , k )}^{2} + α}}$$

$${c}_{z} = - w * \frac{Δ z ( k )}{Δ z ( k ) + Δ z ( k \pm 1 )} * \frac{1}{\sqrt{{m ( i , j , k )}^{2} + α}} ,$$

where w is a weighting coefficient, Δx is a grid size of the initial underground space model in the x direction, Δy is a grid size of the initial underground space model in the y direction, and Δz is a grid size of the initial underground space model in the z direction.
S3, constructing the approximate Jacobian matrix, calculating an iterative equation set based on the approximate Jacobian matrix, and updating the inversion target function based on the iterative equation set to obtain an inversion model.

A construction method of the approximate Jacobian matrix includes following steps:
deriving the parameter vector of the underground space model by adjoint forward to obtain a Jacobian matrix:

$$J = {L}^{T} {K}^{- 1} ( \frac{\partial P}{\partial m} - \frac{\partial K}{\partial m} {E}_{s} ) ,$$

where J is the Jacobian matrix of a forward operator, L is an interpolation operator for converting an electric field component into a magnetic field component, P is an electric field value of a background field, K is the forward operator, and Eₛ is an electric field value of a scattering field;
solving a transposed matrix of the Jacobian matrix:

$${J}^{T} = ( \frac{\partial P}{\partial m} - \frac{\partial K}{\partial m} {E}_{s} ) {K}^{- 1} L .$$

An expression of a design intermediate variable v is:

$$v = {K}^{- 1} L .$$

A calculated equation set may be written as:

$$Kv = {L}^{′} .$$

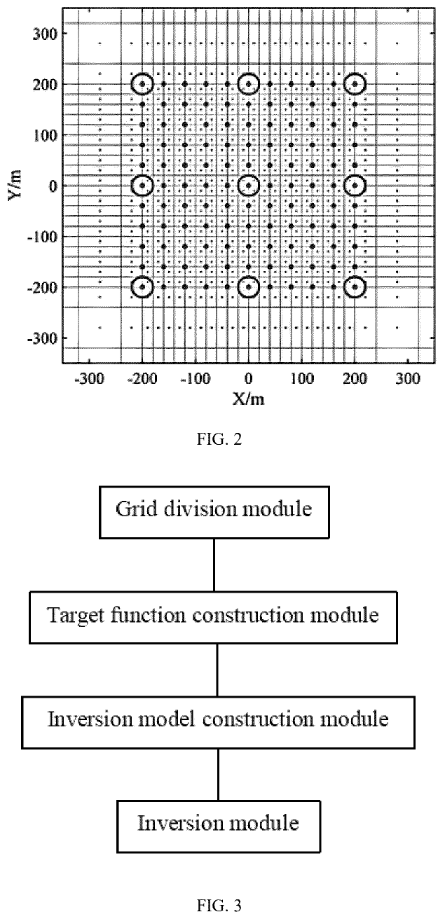

Optimizing the interpolation operator, and selecting four field value calculation points in neighborhood of a measuring point in the divided grids to obtain an approximate interpolation operator L′: in this embodiment, as shown in FIG. 2, the interpolation operator L in the conventional Jacobian matrix calculation method is (Nₓ×N_{y}, 3×Nₓ×N_{y}×N_{z}), and at least Nₓ×N_{y} equation sets (grid center point in FIG. 1) need to be calculated; if four field value calculation points are taken in the vicinity of the measuring point, the approximate operator matrix L′is (4×Nₚ, 3×Nₓ×N_{y}×N_{z}), and only 4×Nₚ equation sets need to be calculated, while the number of measuring point Nₚ is far less than the number of Nₓ×N_{y} field value calculation points. If further approximation is made, only one field value calculation point is taken in the field, and the number of calculated equations may be reduced to Nₚ at most, which significantly reduces the calculation amount.

The approximate interpolation operator replaces an interpolation operator in the transposed matrix to obtain the approximate Jacobian matrix.

A method for obtaining the iterative equation set includes following steps:
calculating a first partial derivative matrix of the observation data with respect to model variables and a second partial derivative matrix of a data difference with respect to the model variables; in this embodiment, firstly, a frequency domain partial derivative matrix of the observation data with respect to the model variables is calculated, and then the frequency domain partial derivative matrix is converted into a time domain partial derivative matrix through time-frequency transformation to obtain the first partial derivative matrix; and calculating the data difference degree and the second partial derivative matrix of the data difference degree to the model variables according to a multi-physical parameter model;
constructing updated variables of the model variables based on the inversion target function and the second partial derivative matrix:

$$Δ m = {( {J}^{T} {W}_{d}^{T} {W}_{d} J + {λ}_{1} {W}_{m}^{T} {W}_{m} + {λ}_{2} {B}_{s}^{T} {B}_{s} )}^{- 1} ( {J}^{T} {W}_{m}^{T} {W}_{m} ( F ( {m}_{0} ) - {d}_{obs} ) - {λ}_{2} {B}_{s}^{T} s )$$

$${λ}_{1} = \frac{{b}_{1}}{{n}_{iter}^{{c}_{1}}} \frac{{‖ {J}^{T} {W}_{d}^{T} {W}_{d} Jx ‖}_{2}}{{‖ {W}_{m}^{T} {W}_{m} x ‖}_{2}}$$

$${λ}_{2} = \frac{{b}_{2}}{{n}_{iter}^{{c}_{2}}} \frac{{‖ {J}^{T} {W}_{d}^{T} {W}_{d} Jx ‖}_{2}}{{‖ {B}_{s}^{T} {B}_{s} x ‖}_{2}} ,$$

where J is the Jacobian matrix of the forward operator, s is the data difference matrix, F(m₀) is a forward numerical simulation value of the reference model vector, Bₛ is the second partial derivative matrix of s about the model variables, nᵢₜₑᵣ is a number of iterations, and b₁, b₂, c₁ and c₂ are constants;
obtaining the iterative equation set based on the updated variables:

$${m}_{k + 1} = {m}_{k} + Δ m ,$$

$${m}_{k + 1} = {m}_{k} + {( {{J}_{k}}^{T} {W}_{d}^{T} {W}_{d} {J}_{k} + {λ}_{1} {W}_{m}^{T} {W}_{m} + {λ}_{2} {B}_{sk}^{T} {B}_{sk} )}^{- 1} ( {{J}_{k}}^{T} {W}_{m}^{T} {W}_{m} ( F ( {m}_{k} ) - {d}_{obs} ) - {λ}_{2} {B}_{sk}^{T} {s}_{k} ) ,$$

where mₖ is a model variable after a k-th iteration, Jₖ is the Jacobian matrix of the forward operator after the k-th iteration, sₖ is the data difference matrix after the k-th iteration, and Bₛₖ is a second partial derivative matrix of sₖ about the model variables; and
inputting the updated model into the forward program, and comparing the data fitting difference between the inversion data and the observation data; if the fitting difference is small enough to meet the set threshold, outputting the inversion results of the different induced polarization parameters, and plotting the inversion results of the induced polarization parameters as the final inversion model; and if the inversion iteration termination condition is not met, recalculating the first partial derivative matrix and the second partial derivative matrix.
S4, inputting aerial transient electromagnetic observation data into the inversion model for inversion to obtain inversion results of each induced polarization parameter.

### Embodiment 2

In this embodiment, as shown in FIG. 3, an aeroelectromagnetic data inversion system based on the approximate Jacobian matrix includes a grid division module, a target function construction module, an inversion model construction module, and an inversion module.

The grid division module is used for grid division of the inversion target area, and setting the initial underground space model based on the divided grids.

In this embodiment, the inversion target area is divided into hexahedral grids, and the initial underground space model is set. If there is a prior model, it may be set as the prior model, and if there is no prior model, it may be set as a uniform half-space model. The transient electromagnetic response of the initial underground space model is obtained by forward calculation of the initial model.

The target function construction module constructs the aerial transient electromagnetic three-dimensional inversion target function based on the initial underground space model, and calculates the weighting term of the model based on the observation data and the inversion target function.

The inversion target function includes:

$$φ ( m ) = {φ}_{d} + {λ}_{1} {φ}_{m 1} + {λ}_{1} {φ}_{m 2}$$

$${φ}_{d} = {[ {d}_{obs} - F ( m ) ]}^{T} {W}_{d}^{T} {W}_{d} [ {d}_{obs} - F ( m ) ]$$

$${φ}_{m 1} = {( m - {m}_{0} )}^{T} {W}_{m}^{T} {W}_{m} ( m - {m}_{0} )$$

$${φ}_{m 2} = {s}^{T} s ,$$

where λ₁ and λ₂ are the regularization factors, W_{d} is the data weighting matrix, Wₘ is the improved model weighting matrix, s is the data difference matrix, d_{obs} is the observation data, F(m) is the transient electromagnetic response of the underground space model, m is the parameter vector of the underground space model, m₀ is the reference model vector of the underground space, and T is the matrix transposition.

It should be noted that m here is a model parameter vector of a current iteration; if no prior model is used, m₀ is the reference model vector of the last iteration in underground space; and if the prior model is used, m₀ is the reference model vector of the prior model in each iteration.

Inputting the observation data (induced electromotive force attenuation curve) and the position of the measuring point into an inversion program, determining the data weighting term according to the data, and the expression of a diagonal matrix of the data weighting term is:

$${W}_{d} = diag ( \frac{1}{\sqrt{{d}_{obs}^{2}}} ) .$$

A calculation method of the weighting term includes: using an improved Laplace operator to calculate the weighting term;
where diagonal elements of the improved Laplace operator are:

$$c = \frac{1}{\sqrt{{m ( i , j , k )}^{2} + α}} ,$$

where m(i,j,k) is an electromagnetic parameter value in the (i,j,k)-th model grid, i is a grid number in the x direction, j is a grid number in the y direction, k is a grid number in the z direction, and α is a constant; and
off-diagonal elements are arranged in a form of central difference, and difference coefficients in three directions are cₓ, c_{y}, and c_{z} respectively:

$${c}_{x} = - w * \frac{Δ x ( i )}{Δ x ( i ) + Δ x ( i \pm 1 )} * \frac{1}{\sqrt{{m ( i , j , k )}^{2} + α}}$$

$${c}_{y} = - w \times \frac{Δ y ( j )}{Δ y ( j ) + Δ y ( j \pm 1 )} \times \frac{1}{\sqrt{{m ( i , j , k )}^{2} + α}}$$

$${c}_{z} = - w * \frac{Δ z ( k )}{Δ z ( k ) + Δ z ( k \pm 1 )} * \frac{1}{\sqrt{{m ( i , j , k )}^{2} + α}} ,$$

where w is a weighting coefficient, Δx is a grid size of the initial underground space model in the x direction, Δy is a grid size of the initial underground space model in the y direction, and Δz is a grid size of the initial underground space model in the z direction.

The inversion model construction module is used to build the approximate Jacobian matrix, calculate the iterative equation set based on the approximate Jacobian matrix, and update the inversion target function based on the iterative equation set to obtain the inversion model.

The construction method of the approximate Jacobian matrix includes following steps:
deriving the parameter vector of the underground space model by adjoint forward to obtain a Jacobian matrix:

$$J = {L}^{T} {K}^{- 1} ( \frac{\partial P}{\partial m} - \frac{\partial K}{\partial m} {E}_{s} ) ,$$

where J is the Jacobian matrix of a forward operator, L is an interpolation operator for converting an electric field component into a magnetic field component, P is an electric field value of a background field, K is the forward operator, and Eₛ is an electric field value of a scattering field;
solving a transposed matrix of the Jacobian matrix:

$${J}^{T} = ( \frac{\partial P}{\partial m} - \frac{\partial K}{\partial m} {E}_{s} ) {K}^{- 1} L .$$

Optimizing the interpolation operator, and selecting four field value calculation points in neighborhood of a measuring point in the divided grids to obtain an approximate interpolation operator L′: in this embodiment, as shown in FIG. 2, the interpolation operator L in the conventional Jacobian matrix calculation method is (Nₓ×N_{y}, 3×Nₓ×N_{y}×N_{z}), and at least Nₓ×N_{y} equation sets (grid center point in FIG. 1) need to be calculated; if four field value calculation points are taken in the vicinity of the measuring point, the approximate operator matrix L′is (4×Nₚ, 3×Nₓ×N_{y}×N_{z}), and only 4×Nₚ equation sets need to be calculated, while the number of measuring point Nₚ is far less than the number of Nₓ X N_{y} field value calculation points. If further approximation is made, only one field value calculation point is taken in the field, and the number of calculated equations may be reduced to Nₚ at most, which significantly reduces the calculation amount.

The approximate interpolation operator replaces the interpolation operator in the transposed matrix to obtain the approximate Jacobian matrix.

A method for obtaining the iterative equation set includes following steps:
calculating a first partial derivative matrix of the observation data with respect to model variables and a second partial derivative matrix of the data difference with respect to the model variables; in this embodiment, firstly, a frequency domain partial derivative matrix of the observation data with respect to the model variables is calculated, and then the frequency domain partial derivative matrix is converted into a time domain partial derivative matrix through time-frequency transformation to obtain the first partial derivative matrix; and calculating the data difference degree and the second partial derivative matrix of the data difference degree to the model variables according to a multi-physical parameter model;
constructing updated variables of the model variables based on the inversion target function and the second partial derivative matrix:

$$Δ m = {( {J}^{T} {W}_{d}^{T} {W}_{d} J + {λ}_{1} {W}_{m}^{T} {W}_{m} + {λ}_{2} {B}_{2}^{T} {B}_{s} )}^{- 1} ( {J}^{T} {W}_{m}^{T} {W}_{m} ( F ( {m}_{0} ) - {d}_{obs} ) - {λ}_{2} {B}_{s}^{T} s )$$

$${λ}_{1} = \frac{{b}_{1}}{{n}_{iter}^{{c}_{1}}} \frac{{‖ {J}^{T} {W}_{d}^{T} {W}_{d} Jx ‖}_{2}}{{‖ {W}_{m}^{T} {W}_{m} x ‖}_{2}}$$

$${λ}_{2} = \frac{{b}_{2}}{{n}_{iter}^{{c}_{2}}} \frac{{‖ {J}^{T} {W}_{d}^{T} {W}_{d} Jx ‖}_{2}}{{‖ {B}_{s}^{T} {B}_{s} x ‖}_{2}} ,$$

where J is the Jacobian matrix of the forward operator, s is the data difference matrix, F(m₀) is a forward numerical simulation value of the reference model vector, Bₛ is the second partial derivative matrix of s about the model variables, nᵢₜₑᵣ is a number of iterations, and b₁, b₂, c₁ and c₂ are constants;
obtaining the iterative equation set based on the updated variables:

$${m}_{( k + 1 )} = {m}_{k} + Δ m ,$$

$${m}_{k + 1} = {m}_{k} + {( {J}_{k}^{T} {W}_{d}^{T} {W}_{d} {J}_{k} + {λ}_{1} {W}_{m}^{T} {W}_{m} + {λ}_{2} {B}_{sk}^{T} {B}_{sk} )}^{- 1} ( {J}_{k}^{T} {W}_{m}^{T} {W}_{m} ( F ( {m}_{k} ) - {d}_{obs} ) - {λ}_{2} {B}_{sk}^{T} {s}_{k} ) ,$$

where mₖ is a model variable after a k-th iteration, Jₖ is the Jacobian matrix of the forward operator after the k-th iteration, sₖ is the data difference matrix after the k-th iteration, and Bₛₖ is a second partial derivative matrix of sₖ about the model variables; and
inputting the updated model into the forward program, and comparing the data fitting difference between the inversion data and the observation data; if the fitting difference is small enough to meet the set threshold, outputting the inversion results of the different induced polarization parameters, and plotting the inversion results of the induced polarization parameters as the final inversion model; and if the inversion iteration termination condition is not met, recalculating the first partial derivative matrix and the second partial derivative matrix.

The inversion module inputs the aerial transient electromagnetic observation data into the inversion model for inversion, and obtains the inversion results of each induced polarization parameter.

### Embodiment 3

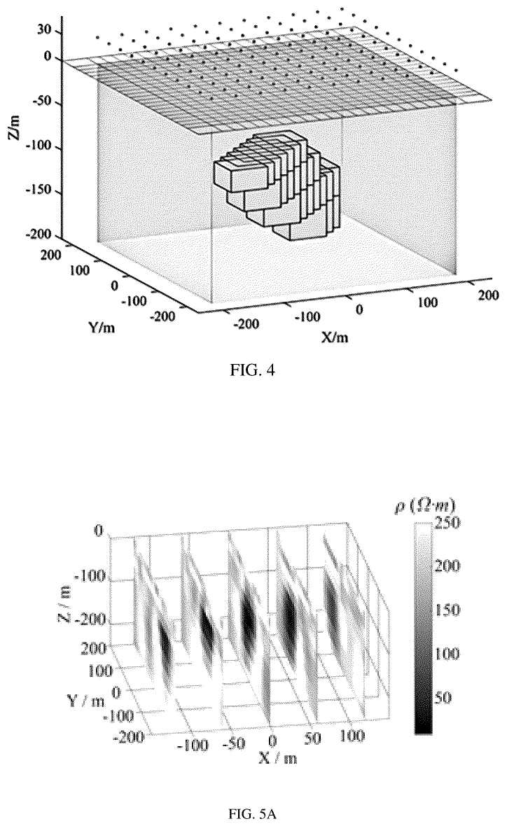

In this embodiment, a set of models as shown in FIG. 4 are designed for calculation, and a hexahedral grid of 28*28*18 is designed. The radius of a transmitting coil is 15 m, and a transmitting current is 100 A. Both the transmitting coil and a receiving coil are located in the air of 30 m, with a total of 121 measuring points. The calculation area is divided into 20 grids at equal intervals in the x and y directions, and the grid size is 20 m. The grid size in the z direction increases gradually from the surface to the depth, and the first grid size is 20 m. After that, the size of each grid is 1.1 times that of the previous grid. The boundary and air area include 8 expanded grids in the x and y directions and 8 grids in the z direction. In a synthetic model, an inclined low-resistance polarizer is buried in a uniform half-space, which gradually becomes deeper from the negative direction of X and Y to the positive direction of X and Y. The surrounding rock resistivity is 200 Ω·m, the polarizability is 0.01, the time constant is 0.0001, and the frequency correlation coefficient is 0.01. The target resistivity is 50 Ω·m, the polarizability is 0.5, the time constant is 0.005, and the frequency correlation coefficient is 0.5. The initial model of inversion is designed as a uniform half-space, with the resistivity of 100 Ω·m, the polarizability of 0.1, the time constant of 0.001 and the frequency correlation coefficient of 0.1.

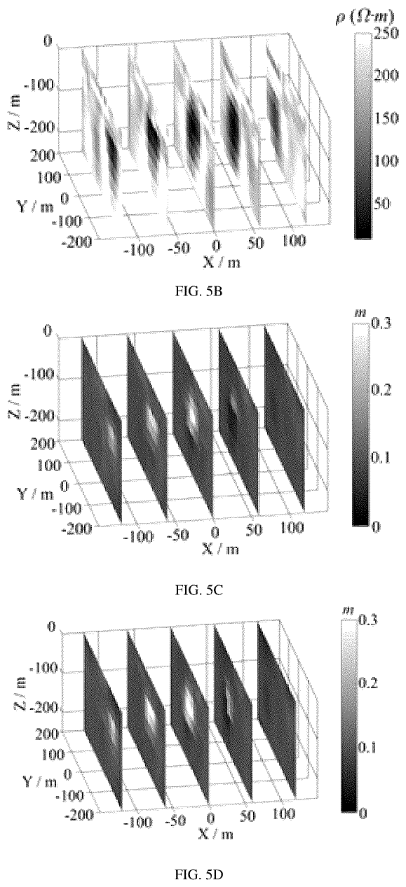

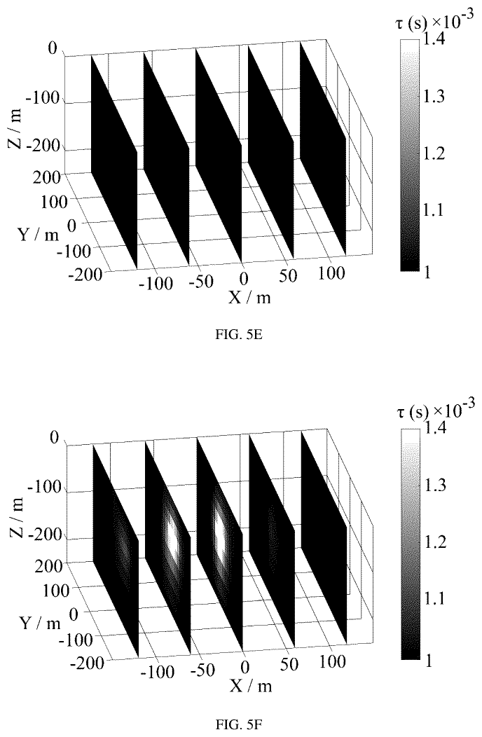

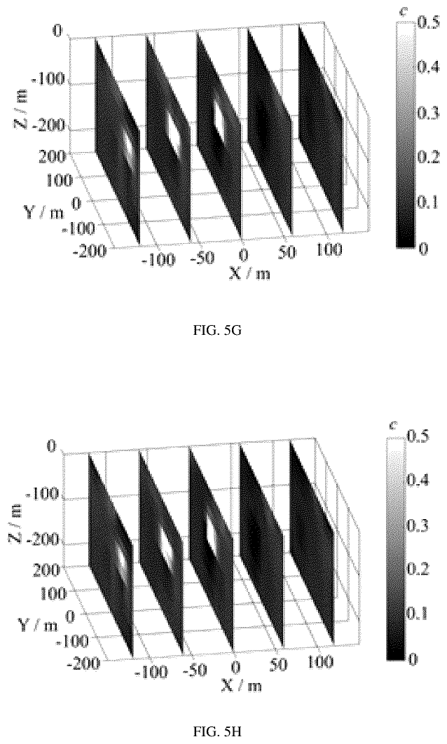

FIG. 5A-FIG. 5H compare the inversion results obtained by two Jacobian matrix calculation methods. The approximate Jacobian matrix calculation method adopts the method with the largest approximation, that is, only the value of one field value calculation point is taken to replace the value of the field value sampling point in the vicinity. From the results, there is no great difference between the inversion results obtained by the accurate Jacobian matrix calculation method and the approximate Jacobian matrix calculation method, and both may well restore the electrical characteristics of underground media.

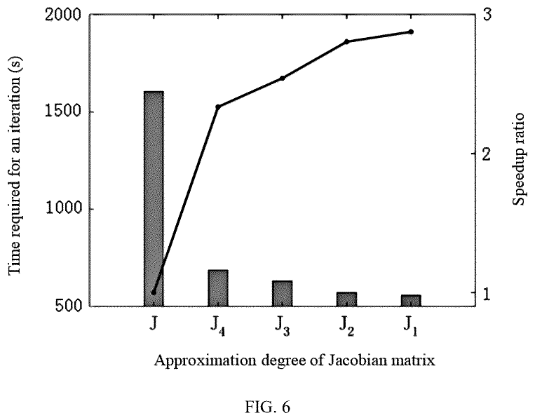

FIG. 6 shows the time and speedup ratio of each iteration of different approximate Jacobian calculation methods. From FIG. 6, it may be clearly seen that this Jacobian matrix approximation method may significantly reduce the time required for each iteration in inversion. When the maximum approximation ratio is selected for calculation, the calculation speed is 2.88 times that of the accurate Jacobian matrix calculation method.

The above-mentioned embodiments only describe the preferred mode of the present disclosure, and do not limit the scope of the present disclosure. Under the premise of not departing from the design spirit of the present disclosure, various modifications and improvements made by ordinary technicians in the field to the technical schemes of the present disclosure should fall within the protection scope of the present disclosure.

1. An aeroelectromagnetic data inversion method based on an approximate Jacobian matrix, comprising following steps:
dividing an inversion target area into grids, and setting an initial underground space model based on divided grids;
constructing an aerial transient electromagnetic three-dimensional inversion target function based on the initial underground space model, and calculating a weighting term of the model based on observation data and the inversion target function;
applying an interpolation operator for converting an electric field component into a magnetic field component based on selected field value calculation points in the neighborhood of a measuring point in the divided grids;
constructing the approximate Jacobian matrix, calculating an iterative equation set based on the approximate Jacobian matrix, and updating the inversion target function based on the iterative equation set to obtain an inversion model;
inputting aerial transient electromagnetic observation data into the inversion model for inversion to obtain inversion results of each induced polarization parameter;
wherein the inversion target function comprises:
$$φ ( m ) = {φ}_{d} + {λ}_{1} {φ}_{m 1} + {λ}_{1} {φ}_{m 2}$$
$${φ}_{d} = {[ {d}_{obs} - F ( m ) ]}^{T} {W}_{d}^{T} {W}_{d} [ {d}_{obs} - F ( m ) ]$$
$${φ}_{m 1} = {( m - {m}_{0} )}^{T} {W}_{m}^{T} {W}_{m} ( m - {m}_{0} )$$
$${φ}_{m 2} = {s}^{T} s ,$$
wherein λ₁ and λ₂ are regularization factors, W_{d} is a data weighting matrix, Wₘ is an improved model weighting matrix, s is a data difference matrix, d_{obs} is observation data, F(m) is transient electromagnetic response of the underground space model, m is a parameter vector of the underground space model, m₀ is a reference model vector of the underground space, and T is a matrix transposition;
a construction method of the approximate Jacobian matrix comprises following steps:
deriving the parameter vector of the underground space model by adjoint forward to obtain a Jacobian matrix:
$$J = {L}^{T} {K}^{- 1} ( \frac{\partial P}{\partial m} - \frac{\partial K}{\partial m} {E}_{s} ) ,$$
wherein J is the Jacobian matrix of a forward operator, L is the interpolation operator for converting the electric field component into a-the magnetic field component, P is an electric field value of a background field, K is the forward operator, and Eₛ is an electric field value of a scattering field;
solving a transposed matrix of the Jacobian matrix:
$${J}^{T} = ( \frac{\partial P}{\partial m} - \frac{\partial K}{\partial m} {E}_{s} ) {K}^{- 1} L ;$$
optimizing the interpolation operator, and selecting four field value calculation points in neighborhood of a measuring point in the divided grids to obtain an approximate interpolation operator L′; and
replacing an interpolation operator in the transposed matrix of the Jacobian matrix with the approximate interpolation operator to obtain the approximate Jacobian matrix;
a method for obtaining the iterative equation set comprises following steps:
calculating a first partial derivative matrix of the observation data with respect to model variables and a second partial derivative matrix of a data difference with respect to the model variables;
constructing updated variables of the model variables based on the inversion target function and the second partial derivative matrix:
$$Δ m = {( {J}^{T} {W}_{d}^{T} {W}_{d} J + {λ}_{1} {W}_{m}^{T} {W}_{m} + {λ}_{2} {B}_{2}^{T} {B}_{s} )}^{- 1} ( {J}^{T} {W}_{m}^{T} {W}_{m} ( F ( {m}_{0} ) - {d}_{obs} ) - {λ}_{2} {B}_{s}^{T} s )$$
$${λ}_{1} = \frac{{b}_{1}}{{n}_{iter}^{{c}_{1}}} \frac{{‖ {J}^{T} {W}_{d}^{T} {W}_{d} Jx ‖}_{2}}{{‖ {W}_{m}^{T} {W}_{m} x ‖}_{2}}$$
$${λ}_{2} = \frac{{b}_{2}}{{n}_{iter}^{{c}_{2}}} \frac{{‖ {J}^{T} {W}_{d}^{T} {W}_{d} Jx ‖}_{2}}{{‖ {B}_{s}^{T} {B}_{s} x ‖}_{2}} ,$$
wherein J is the Jacobian matrix of the forward operator, s is the data difference matrix, F(m₀) is a forward numerical simulation value of the reference model vector, Bₛ is the second partial derivative matrix of s about the model variables, nᵢₜₑᵣ is a number of iterations, and b₁, b₂, c₁, and c₂ are constants;
obtaining the iterative equation set based on the updated variables:
$${m}_{( k + 1 )} = {m}_{k} + Δ m ,$$
$${m}_{k + 1} = {m}_{k} + {( {J}_{k}^{T} {W}_{d}^{T} {W}_{d} {J}_{k} + {λ}_{1} {W}_{m}^{T} {W}_{m} + {λ}_{2} {B}_{sk}^{T} {B}_{sk} )}^{- 1} ( {J}_{k}^{T} {W}_{m}^{T} {W}_{m} ( F ( {m}_{k} ) - {d}_{obs} ) - {λ}_{2} {B}_{sk}^{T} {s}_{k} ) ,$$
wherein mₖ is a model variable after a k-th iteration, Jₖ is the Jacobian matrix of the forward operator after the k-th iteration, sₖ is the data difference matrix after the k-th iteration, and Bₛₖ is a second partial derivative matrix of sₖ about the model variables; and
inputting an updated model into a forward program, and comparing a data fitting difference between inversion data and the observation data; if the fitting difference is small enough to meet a set threshold, outputting the inversion results of different induced polarization parameters, and plotting the inversion results of the induced polarization parameters as a final inversion model; and
if an inversion iteration termination condition is not met, recalculating the first partial derivative matrix and the second partial derivative matrix.

2. The aeroelectromagnetic data inversion method based on the approximate Jacobian matrix according to claim 1, wherein a calculation method of the weighting term comprises: using an improved Laplace operator to calculate the weighting term;
wherein diagonal elements of the improved Laplace operator are:
$$c = \frac{1}{\sqrt{{m ( i , j , k )}^{2} + α}} ,$$
wherein m(i,j,k) is an electromagnetic parameter value in the (i,j,k)-th model grid, i is a grid number in x direction, j is a grid number in y direction, k is a grid number in z direction, and a is a constant; and
off-diagonal elements are arranged in a form of central difference, and difference coefficients in three directions are cₓ, c_{y}, and c_{z}, respectively:
$${c}_{x} = - w * \frac{Δ x ( i )}{Δ x ( i ) + Δ x ( i \pm 1 )} * \frac{1}{\sqrt{{m ( i , j , k )}^{2} + α}}$$
$${c}_{y} = - w \times \frac{Δ y ( j )}{Δ y ( j ) + Δ y ( j \pm 1 )} * \frac{1}{\sqrt{{m ( i , j , k )}^{2} + α}}$$
$${c}_{z} = - w * \frac{Δ z ( k )}{Δ z ( k ) + Δ z ( k \pm 1 )} * \frac{1}{\sqrt{{m ( i , j , k )}^{2} + α}} ,$$
wherein w is a weighting coefficient, Δx is a grid size of the initial underground space model in the x direction, Δy is a grid size of the initial underground space model in the y direction, and Δz is a grid size of the initial underground space model in the z direction.

3. (canceled)

4. (canceled)
